(19) United States
(12) Patent Application Publication
(10) Pub. No.: US 2004/0025400 A1
(43) Pub. Date: Feb. 12, 2004

(54) Water fowl motion decoy

(76) Inventor: Joseph L. Salato, Bloomington, MN (US)

Correspondence Address: BRIGGS AND MORGAN, P.A., 2400 IDS CENTER, MINNEAPOLIS, MN, 55402, US

(21) Appl. No.: 10/437,731

(22) Filed: May 13, 2003

Related U.S. Application Data
(63) Continuation-in-part of application No. 29/163,565, filed on Jul. 8, 2002, now Pat. No. D475759.

(51) Int. Cl. A01M 31/06

(52) U.S. Cl. 43/3

(57) ABSTRACT

A motion waterfowl decoy has a body with two sets of eyelet guides. Flexible, resilient wings are secured to the body and extend upwardly and away from the body. The body defines slots to secure the wings to the body by fitting the wings within the slots. An actuator is connected to the upper portion of the wings and passes through the at least one set of eyelet guides. The actuator and the guides are configured to confer movement to the wing by flexing the wing downwardly and inwardly. The wing may be covered with flexible material or have a flexible material secured to about a flexible resilient rib to confer more realistic movement, shape and/or appearance to the wing. Further the wing may include a hinge and a spring, wherein the spring is biased against the hinge to maintain the wing in an extended upward position.

### RELATED U.S. APPLICATIONS

This is a continuation-in-part of U.S. application Ser. No. 29/163,565, filed Jul. 8, 2002.

### BACKGROUND OF THE INVENTION

1. Field of the Invention

The present invention relates to decoys. In particular, the present invention relates to waterfowl motion decoys.

2. Description of the Related Art

Waterfowl hunting has seen a growing popularity over recent years. In spite of the increasing number of hunters, conservation and preservation efforts as well as regulation of hunting, there has been a growing number of waterfowl. In fact, the number of waterfowl and the interest in waterfowl hunting are at an all time high. Hunters have historically used decoys to increase the likelihood of ducks coming into range. Particularly, waterfowl decoys have been used by hunters in an effort to attract ducks and other waterfowl to a particular body of water or to a particular location in a body of water. Traditionally, such decoys have been made as inanimate structures that are placed on a body of water and allowed to float passively thereon, without movement of any kind. These traditional decoys are typically simple plastic or wood, waterfowl-shaped forms which present no moving features and are used to attract live waterfowl.

These motionless decoys have historically been reasonably effective in attracting waterfowl. However, waterfowl adapt to changes in their environment, and in response to increased hunting pressure many waterfowl have become more cautious in their behavior and are becoming more weary of motionless decoys. It appears that many waterfowl have learned to distinguish the difference between live birds and stationary decoys. Among the primary difference between live birds and traditional decoys are the movement and the splashing of the water that is associated with the live birds. Accordingly, a need exists for a decoy that can provide the necessary movement and splash to attract weary waterfowl.

To attempt to solve this problem, hunters and decoy manufacturers have attempted to add various types of motion to their decoys. For example, some decoys have integrated electrical and mechanical motors to provide motion to the decoy. The particular motions of the decoys vary but, include, vibrating motion to cause ripples on the water, propelling the decoy over the water; flapping or rotating wings, moving heads and combinations of these movements. The creation of the movement frequently involves complex mechanical structure that adds to the cost of production and to the difficulty of use.

Therefore, a need exists for a waterfowl motion decoy that is simple to produce and use. Further, the movements are typically generated by electrical or mechanical motors requiring batteries and, when subject to conditions in the field, are frequently subject to failure. Therefore, a need exists for a robust manual mechanism for generating movement. In addition, some jurisdictions are placing restrictions on the use of motorized decoys. This creates a need to for a manual motion waterfowl decoy which may be used in view of the restrictions and drawbacks.

### SUMMARY OF THE INVENTION

A motion waterfowl decoy has a body with two sets of eyelet guides. Flexible, resilient wings are secured to the body and extend upwardly and away from the body. The body defines slots to secure the wings to the body by fitting the wings within the slots. An actuator is connected to the upper portion of the wings and passes through the at least one set of eyelet guides. The actuator and the guides are configured to confer movement to the wing by flexing the wing. The wing may be covered with flexible material or have a flexible material secured about a flexible resilient rib to confer more realistic movement, shape and/or appearance to the wing. Further, the wing may include a hinge and a spring, wherein the spring is biased against the hinge to maintain the wing in an extended upward position.

The apparatus and method of the present invention satisfies the above needs and provides additional advantages that will be recognized by those skilled in the art upon review of the present disclosure.

In one aspect, the present invention provides a motion decoy that more effectively attracts waterfowl than a stationary decoy.

In another aspect, the present invention provides a motion decoy with a robust mechanism to facilitate movement of at least a portion of the decoy.

In yet another aspect, the present invention provides a motion decoy wherein the motion for attracting waterfowl is produced without the need for electrical or complex mechanical component.

In yet another aspect, the present invention may provide for remote operation of the decoy.

Another object is that the present invention splashes the water when used over water which further attracts waterfowl.

In still another aspect, the present invention provides the motion to the motion decoy without the noise of electrical or mechanical motors.

### BRIEF DESCRIPTION OF THE DRAWINGS

The invention will now be described, purely by way of non-restrictive example, with reference to the accompanying drawings, in which:

FIG. 1 illustrates a perspective view of an embodiment of motion decoy in accordance with the present invention.

FIG. 2 illustrates a perspective view of another embodiment of motion decoy in accordance with the present invention.

FIG. 3 illustrates a side view of a motion decoy of FIG. 1.

FIG. 4 illustrates a top view of the motion decoy of FIG. 1.

FIG. 5 illustrates a front view of the motion decoy of FIG. 1 with the wings in an extended more relaxed position and with the wings in a compressed downward position in phantom.

FIG. 6 illustrates a perspective view of an embodiment of the wing in a relaxed position.

FIG. 7 illustrates a partial side view of an embodiment of a spring-loaded hinge for biasing an embodiment of the wing in the extended position.

All figures are drawn for ease of explanation of the basic teachings of the present invention only; the extensions of the figures with respect to number, position relationship and dimensions of the parts to form the preferred embodiment will be explained or will be within the skill of the arts after the following description has been read and understood. Further, the exact dimensional proportions to conform to specific force, weight, strength, and similar requirements will likewise be within the skill of the art after the following description has been read and understood.

Where used in various figures of the drawings, the same numerals designate the same or similar parts. Furthermore, when the terms “top,” “bottom,” right,” “left,” “forward,” “rear,” “first,” “second,” “inside,” “outside,” and similar terms are used, the terms should be understood to reference only the structure shown in the drawings as it would appear to a person viewing the drawings and utilized only to facilitate the description of the illustrated embodiment.

### DETAILED DESCRIPTION OF THE INVENTION

A motion waterfowl decoy 10 in accordance with the present invention is generally illustrated in the Figures. Motion decoy 10 is generally configured to attract waterfowl. Particularly, motion decoy 10 is shaped and shaded to generally resemble a goose for exemplary purposes only. Those skilled in the art will recognize variations of the present invention may be used to attract a wide range of game birds. Motion decoy 10 generally includes a body 12, two identical wings 14, at least one actuator 16 and one or more eyelet guides 18. Motion decoy 10 may further include a base or stake 20 to secure motion decoy 10 in a desired position or to maintain the decoy in an upright position during use.

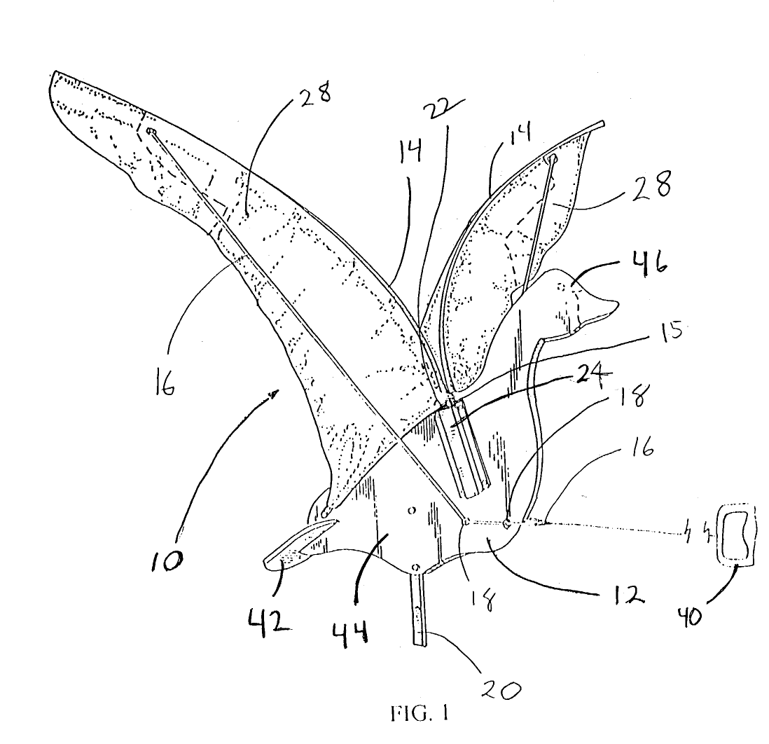

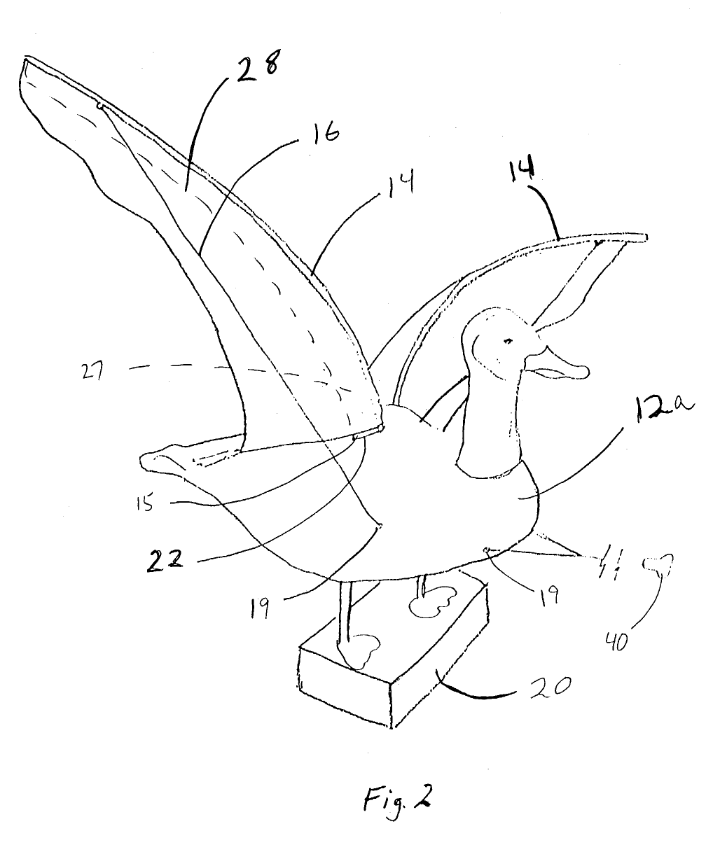

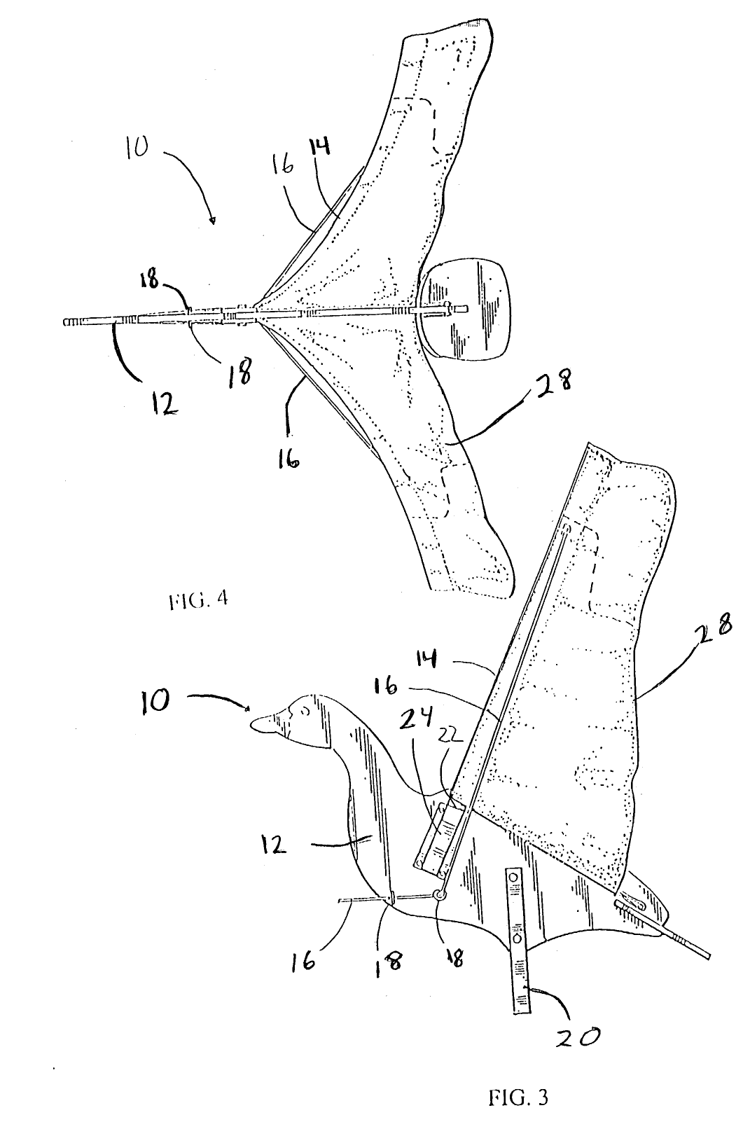

Body 12 is generally configured to resemble a game bird of interest. Body 12 may include a tail portion 42, body portion 44 and a head portion 46. Body 12 may be formed from a flat sheet silhouette material that is cut to resemble a game bird in profile, as generally illustrated in FIGS. 1, 3, 4, and 5. When cut from a generally flat sheet of material, body 12 may be formed from a material such as plastic, fiberglass, fiber board, wood, cardboard, metal or other material that will be recognized by those skilled in the art upon review of the present disclosure. Body 12a may also be formed in a more three-dimensional configuration to more accurately resemble the game bird from more than just the profile, as generally illustrated in FIG. 2. In the three-dimensional configuration, body 12a may be manufactured from Styrofoam, molded plastic, wood, rubber, fiberglass, or other materials that will be recognized by those skilled in the art upon review of the present disclosure.

Body 12a includes one or more slots 22 to receive each wing 14. When the body is formed from a generally flat sheet of material as is generally illustrated in FIGS. 1, 3, 4, and 5, body 12 may include a receiver 24 secured to the side of the body to form slot 22. When the body 12a is the three-dimensional configuration, slots 22 may be formed integrally with body 12 as is illustrated in FIG. 2. As illustrated for exemplary purposes, slot 22 is formed to extend into body 12.

Two wings 14 are provided and are secured to body 12. Wings 14 are typically formed from a flexible reinforcing bar, rib or rod 15, as is generally illustrated in FIG. 6. The rib 15 is captured by sleeve 27 of wing-like flexible material 28, thereby resembling the wing of a game bird. The flexible and resilient material 28 may be fabric or plastic while rib 15 may be plastic, fiberglass, wood, metal, or other flexible materials.

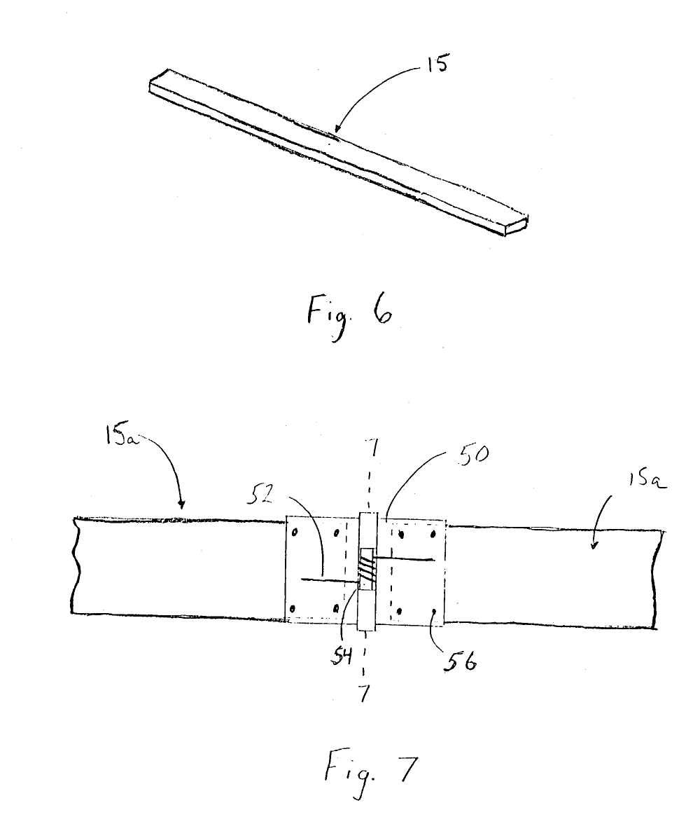

Alternatively, rib 15a include an interposed hinge 50 as illustrated in FIG. 7 to confer flexibility to wing 14 should rib 15a not have sufficient flexibility. Hinge 50 may include a pin 54 which can define an axis 7-7 about which hinge 50 flexes. A spring 52 may be provided to bias wing 14 into an upward extended position.

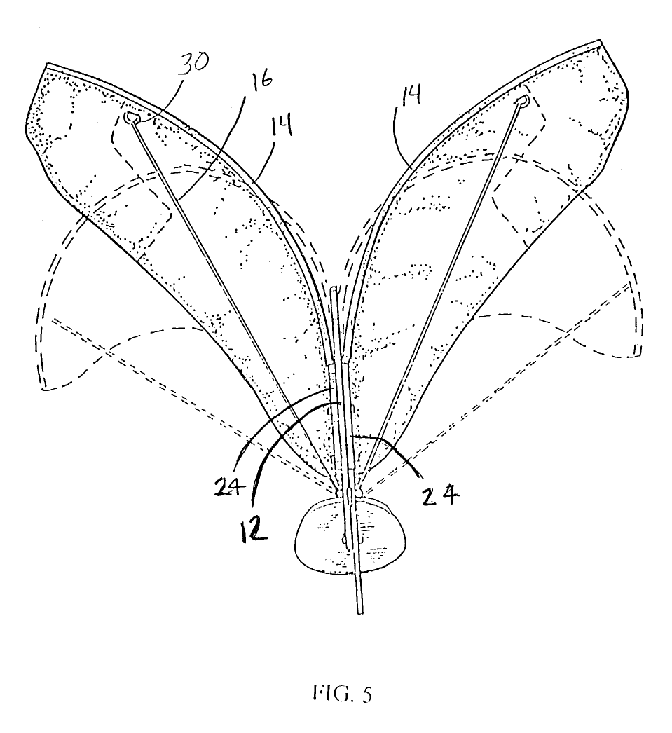

As is generally illustrated throughout the figures, wings 14 are shown generally in an upward extended position. In FIG. 5, the wings are flexed, flapped or cupped downwardly (shown in phantom) to a position inwardly to emulate generally the movement of the flapping of game birds' wings.

At least one actuator 16 is secured to wing 14 to apply a force to move wings 14 from the extended to the flexed positions. As illustrated, actuator 16 is in the form of a string secured to wing 14 through an eyelet 30 attached to wing 14. Actuator 16 may take the form of a string, wire, line, rod or other form that will permit actuator to confer a moving force to wing 14. Actuator 16 is passed through one or more eyelet guides 18 to confer the desired movement to the wings. Typically, eyelet guides 18 are positioned below the wings on body 12 although eyelet guides 18 may be positioned in any number of locations to confer the desired movement to wings 14. Alternatively, guides may take the form of a passage 19 defined by the body as is illustrated in FIG. 2 for exemplary purposes.

An exemplary embodiment for the movement is generally illustrated in FIG. 5. FIG. 5 generally shows the wings in an exemplary extended position while illustrating an exemplary flexed position in phantom. As illustrated throughout the figures for exemplary purposes, actuator 16 can confer a degree of flex to wings 14 even when wings 14 are in the extended position. Actuator 16 may be provided with a remote handle 40 to permit a user to apply a force to actuator 16 which will be conferred as a flexing force to wings 14. In one aspect, the repeated application and removal of such force can provide a flapping motion to wings 14.

A base 20 may be secured to body 12. Generally, base 20 functions to secure motion decoy 10 in a desired position. Base 20 can be weighted, may be driven into the ground, driven into mud over water, or may otherwise function to secure decoy 10 in a desired location. Alternatively, base 20 may be configured to permit motion decoy 10 to float on the surface of the water while allowing the user to move the wings by application of force to actuator 16. Wings 14 will also splash the water, further imitating waterfowl.

Since the invention disclosed above may be embodied in other specific forms without departing from the spirit or general characteristics thereof, some of which forms have been indicated, the embodiments described in the present disclosure are to be considered in all respects illustrative and not restrictive. The scope of the invention is to be indicated by the appended claims, rather than by the above description, and all changes which come within the meaning and range of equivalency of the claims are intended to be embraced by the claims.

What is claimed is:

1. A motion waterfowl decoy, comprising:
(a) a body having at least one guide;
(b) at least one wing securable to the body and extending upwardly from the body to a resting state; and
(c) an actuator connected to the at least one wing and passing through the at least one guide, wherein the at least one guide is positioned on the body to flex the at least one wing when the actuator is moved.

2. The motion decoy of claim 1, further comprising a base configured to secure motion the body in a desired position.

3. The motion decoy of claim 1, wherein the at least one guide is positioned on the body to flex the at least one wing in a flapping motion.

4. The motion decoy of claim 1, wherein the body is formed from flat sheet material.

5. The motion decoy of claim 1, wherein the wing is shaped as a wing of a game bird.

6. The motion decoy of claim 1, further comprising a flexible material secured to at least a portion of the wing.

7. The motion decoy of claim 1, wherein the at least one wing further comprises a hinge and a spring, wherein the spring is biased against the hinge to maintain the first rigid section and the second rigid section in an extended position.

8. The motion decoy of claim 1, further comprising the body defining at least one slot to receive the at least one wing, wherein the at least one wing is secured to the body by being received within the at least one slot.

9. The motion decoy of claim 8, wherein the slot is defined by a receiver secured to a side of the body.

10. The motion decoy of claim 1, wherein the line has a handle attached at a distal end of the actuator.

11. The motion decoy of claim 1, wherein the actuator is a line.

12. The motion decoy of claim 11, wherein the line has a handle attached at a distal end of the line.

13. A waterfowl motion decoy, comprising:
(a) a silhouette body;
(b) two flexible, resilient wings securable to the body and extending upward and outward from the body to a resting state;
(c) two pair of eyelet guides wherein one eyelet guide of each pair is below the wing and the second eyelet guide is forward of the one eyelet guide below the wing; and
(d) two actuator cords, each fastened to an upper portion of one of the wings and passing through one pair of eyelet guides to pull the wings downwardly and inwardly.

14. The motion decoy of claim 13, further comprising slots in the body to receive a downwardly extending rib protruding from each of the wings.

15. The motion decoy of claim 13, wherein the wings are each of a flexible material with a forward sleeve to receive a reinforcing flexible rib.

16. A waterfowl motion decoy, comprising:
(a) a formed body;
(b) two flexible, resilient wings securable to the body and extending upward and outward from the body to a resting state;
(c) Two actuator cords, each fasten to an upper portion of one or the wings; and
(d) guides on the body to slidably capture the actuator cords to assist in pulling the wings downwardly and inwardly.

17. The motion decoy of claim 16, further comprising slots in the body to receive a downwardly extending rib protruding from each of the wings.

18. The motion decoy of claim 16, wherein the wings are each of a flexible material with a forward sleeve to receive a reinforcing flexible rib.
